(19) United States
(12) Patent Application Publication
(10) Pub. No.: US 2004/0094145 A1
(43) Pub. Date: May 20, 2004

(54) Method for producing microspherical crystallites from linear polysaccharides, corresponding microspherical crystallites and the suse thereof

(76) Inventors: Stephan Hausmanns, Wiesbaden (DE); Thomas Kiy, Frankfurt am Main (DE); Ivan Tomka, Zurich (CH); Rolf Muller, Zurich (CH); Peter Mertins, Marburg (DE)

Correspondence Address: Robert H Hammer III, Suite I, 3121 Springbank Lane, Charlotte, NC, 28226, US

(21) Appl. No.: 10/415,204

(22) PCT Filed: Oct. 25, 2001
(86) PCT No.: PCT/EP01/12354

(30) Foreign Application Priority Data
Oct. 26, 2000 (DE) 10053267.5

(51) Int. Cl. C08B 30/00; C08B 37/00

(52) U.S. Cl. 127/34; 536/123

(57) ABSTRACT

The invention relates to a method for producing microspherical crystallites with a uniform spherical shape and an extremely narrow size distribution. Said crystallites consist wholly or partially of a linear water-insoluble polysaccharide, preferably of 1,4-α-D-polyglucane, have a degree of crystallinity of >80% and can contain additional polymers and/or active ingredients, which are in particular biodegradable. They are particularly suitable for the controlled release of active ingredients. They are produced by fusing 1,4-α-D-polyglucane or the polysaccharide in water, introducing the fusion into a precipitant, cooling the mixture and separating the particles that have formed.

The present invention relates to a novel method for producing microspherical crystallites which comprise linear polysaccharides, to these microspherical crystallites, and to the use thereof.

The method for producing particles, in particular microparticles from polymers such as, for example, polysaccharides, for a wide variety of applications are however complicated methods requiring accurate compliance with various parameters. In particular, many methods also lead to only small yields and to very wide particle distributions. Mention should be made in this context in particular of spray drying, interfacial condensation and emulsion methods (for example WO methods=water-in-oil emulsions, WOW=water-in-oil-in-water emulsions, coacervation, phase separation, dispersion). Emulsion methods in particular, but also spray dryings from two-phase systems, require a very accurate procedure and, in most cases, the use of auxiliaries (emulsifiers). Stable emulsions can often be produced only at great expense and with precise control of a large number of parameters (temperature, stirring speed, etc.), and comprehensive removal of the particles involves problems. The yield of particles is often very low and, in particular, the proportion of active substances entrapped is inadequate. This is an aspect which may prevent application of a technology in the case of costly pharmaceutical active substances.

Spherical microparticles which, besides tartaric acid-containing polycondensates may also contain ethyl starch or other polysaccharides are obtained, according to U.S. Pat. No. 5,391,696, on the one hand by the spray-drying method, but with which the particle size and, in particular, the size distribution can be controlled only with great difficulty. Another possibility described in this patent is to dissolve the polymer in a solvent or mixture of solvents and to add the solution dropwise to a cold liquefied gas, e.g. liquid nitrogen, with formation of microparticles. The microparticles can then be introduced into water, which simultaneously precipitates the polymer and extracts the solvent. This method is time-consuming, costly and uneconomic. The uniformity of the particle dimensions is also unsatisfactory.

EP-B1-0 251 476 describes the production of microparticles from polylactides in which a macromolecular polypeptide is dispersed. Intensive control of a wide variety of parameters is necessary in this case too. Uniform spherical particles are not obtained.

Microparticles which contain active substances and gases are described in WO 95/07072. Production takes place by elaborate emulsion methods, and the size distribution of the particles is very inhomogeneous.

Yu Jiugao and Liu Jie report in starch/stärke 46(7), 252-5, (1994) on the effects of the suspension crosslinking reaction conditions on the size of starch microparticles. The crosslinking takes place in three stages; the medium is a water-in-oil suspension, and a peanut oil/toluene mixture is used as oil phase. Pregelatinized starch is added as aqueous solution which still contains sodium hydroxide and ethylenediaminetetraacetic acid. The presence of a surface-active agent or stabilizer is also necessary.

The disadvantage of the method described therein is that the result depends on a large number of factors, namely on the density, the viscosity and the concentration ratios both of the aqueous and of the oil phase, on the stabilizer and on the stirring speed, and, in addition, the presence of the stabilizer is a disadvantage. It is moreover difficult to control the large number of parameters given, so that the reproducibility is unsatisfactory.

Particles which are loaded with macromolecular active substances and are composed of water-insoluble polymers such as polylactic acid or ethyl-cellulose are obtained, according to the disclosure of EP-B1-0 204 476, by suspending the particulate active substance in an acetone solution of the polymer, and evaporating off the solvent at room temperature. The particles resulting in this case still do not show the required pharmacological effects, so that further processing to so-called pellets is necessary.

The publication GB 2247242 discloses a method for producing micro-particles from a water-soluble material resulting from the action of the enzyme CGTase (EC 2.4.1.19) and, where appropriate, a starch-debranching enzyme on cyclodextrins and/or starch.

The applicant's publication DE 197 37 481.6 discloses microspherical crystallites composed of linear, water-insoluble polysaccharides. These microspherical crystallites are suitable for overcoming the disadvantages listed above. In particular, these microspherical crystallites are evenly structured, have a relatively large uniformity and have diverse possible uses. This publication also describes methods for producing these micro-spherical crystallites.

The corresponding method for producing these microspherical crystallites is distinguished inter alia by dissolving the linear polysaccharides in DMSO, and forming the microspherical crystallites by precipitation in water. The disadvantages of this are that the production costs are relatively high owing to the use of DMSO, and that DMSO-containing waste must be disposed of as special waste, and that appropriate purification of the microspherical crystallites is necessary if they are to be employed for example in the drugs, cosmetics or food sector, because DMSO must not be used for example for producing cosmetics (see German cosmetics regulations, Annex 1, No. 338).

It was therefore an object of the present invention to provide a novel production method that overcomes the aforementioned disadvantages and makes it possible to produce crystallites similar to the microspherical crystallites disclosed in DE 197 37 481.6 in a less expensive and more environmentally friendly manner without using DMSO, which would also make them more suitable for use in the drugs, food and cosmetics sectors.

It has now been found, surprisingly, that very uniform microspherical crystallites can be produced in large amounts by a very simple method from water-insoluble linear polysaccharides in crystalline form, which amounts are not obtained with similar commercially available polysaccharides such as, for example, amylose or starch without the need to use DMSO for producing them, as described in DE 197 37 481.6.

It has additionally been found, surprisingly, that the microcrystallites obtainable in this way have a crystallinity of at least 80%.

The invention therefore relates to a method for producing microspherical crystallites which consist wholly or partly of linear polysaccharides, in particular 1,4-α-D-polyglucan, which comprises (i) melting the linear polysaccharide(s) in water at 130-200° C. under a pressure p>1 bar, and (ii) producing the microspherical crystallites by precipitation in a precipitant at 20-90° C.

The invention further relates to the microspherical crystallites obtainable by the above method, whose proportion of crystalline structure based on the overall structure (degree of crystallinity) is according to the invention at least 80%, preferably at least 90%, particularly preferably at least 95% and very particularly preferably more than 98%.

The crystallinity of the crystallites can be determined for example by X-ray structural analysis or via the density of the particles in a manner known per se. The crystallinity is particularly preferably determined via wide-angle X-ray scattering.

Starches of type A and B differ through their crystalline structure, with type A starches being more densely packed and having a lower water content.

The terms “melting” and “melt” mean according to the invention respectively a process and an end point of a process in which a clear solution is obtained from a cloudy dispersion of the polyglucan in water. The temperature at which such a clear solution is obtained depends on the water content in the polyglucan/water mixture.

Microspherical crystallites mean crystallites having an approximately spherical shape. A sphere is described by axes of equal length which start from a common origin, are directed into space and define the radius of the sphere in all directions in space, a deviation of the lengths of the axes from the ideal spherical state of from 1% to 40% is possible for the microspherical crystallites. The resulting microspherical crystallites have deviations preferably of up to 25%, particularly preferably of up to 15%. The surface of the microspherical crystallites may be compared macroscopically with that of a raspberry, and the depth of the “recesses” or “indentations” should not be more than 20% of the average diameter of the microspherical crystallites.

Linear polysaccharides for the purposes of the present invention are composed of monosaccharides as monomeric building blocks in such a way that the individual building blocks are always linked together in the same way. Each basic unit or building block defined in this way has exactly two linkages, in each case one to another monomer. Exceptions to this are merely the two basic units which form the start and end of the polysaccharide. These have only one linkage to another monomer and form the end groups of the linear polysaccharide.

If the basic unit has three or more linkages, the branch is said to be present. The so-called degree of branching is derived from the number of hydroxyl groups per 100 basic units which are not involved in the structure of the linear polymer backbone and which form branches.

The linear water-insoluble polysaccharides have according to the invention a degree of branching not exceeding 2.5%, i.e. 25 branches per 1 000 monomers.

Preferred polysaccharides have a degree of branching in position 6 which is less than 1%, preferably not more than 0.5%, and in the other positions, e.g. in position 2 or 3, is preferably in each case not more than 2%, and in particular not more than 1%.

Particular preference is also given to polysaccharides whose degree of branching in position 6 is less than 0.5%.

Polysaccharides particularly suitable for the invention are those having no branches.

In exceptional cases, the degree of branching thereof may be so small that it can no longer be detected by conventional methods.

The term “water-insoluble polysaccharides” means for the present invention compounds which fall into the categories of “sparingly soluble”, “slightly soluble”, “very slightly soluble” and “practically insoluble” compounds as defined in the German Pharmacopoeia (DAB=Deutsches Arzneimittelbuch, Wissenschaftliche Verlagsgesellschaft mbH, Stuttgart, Govi-Verlag GmbH, Frankfurt, 9th edition, 1987), corresponding to classes 4 to 7.

Polysaccharides which are preferred according to the invention can therefore be assigned to class 4 of the DAB, i.e. that a saturated solution of the polysaccharide at room temperature and atmospheric pressure comprises about 30 to 100 parts by volume of solvent, i.e. water, per part by mass of substance (1 g of substance per 30-100 ml of water). Polysaccharides which are more preferred according to the invention can be assigned to class 5 of the DAB, i.e. that a saturated solution of the polysaccharide at room temperature and atmospheric pressure comprises about 100 to 1 000 parts by volume of solvent, i.e. water, per part by mass of substance (1 g of substance per 100-1 000 ml of water). Polysaccharides which are even more preferred according to the invention can be assigned to class 6 of the DAB, i.e. that a saturated solution of the polysaccharide at room temperature and atmospheric pressure comprises about 1 000 to 10 000 parts by volume of solvent, i.e. water, per part by mass of substance (1 g of substance per 1 000-10 000 ml of water). Polysaccharides which are most preferred according to the invention can be assigned to class 7 of the DAB, i.e. at a saturated solution of the polysaccharide at room temperature and atmospheric pressure comprises about 10 000 to 100 000 parts by volume of solvent, i.e. water, per part by mass of substance (1 g of substance per 10 000-100 000 ml of water).

The average degree of polymerization (DP) of the polysaccharides of the invention is 20-400, preferably 30-150, particularly preferably 44-100, and very particularly preferably 50-70. In the case of the particularly preferred poly-α-1,4-D-glucan, the DP can be found by simple division of the Mn, i.e. of the number average molecular weight, by the molecular weight of the individual unit (about 162).

Preferred within the scope of the invention are linear, water-insoluble polysaccharides which have been produced in a biotechnological, in particular in a biocatalytic or biotransformational, or a fermentation process.

Linear polysaccharides produced by biocatalysis (also: biotransformation) within the scope of this invention means that the linear polysaccharide is produced by catalytic reaction of monomeric basic building blocks such as oligomeric saccharides, e.g. of mono- and/or disaccharides, by using a so-called biocatalyst, normally an enzyme, under suitable conditions.

Linear polysaccharides from fermentations are, in the terminology of the invention, linear polysaccharides which are obtained by fermentation processes using naturally occurring organisms such as fungi, algae or bacteria or using non-naturally occurring organisms but with the assistance of natural organisms which have been modified by genetic engineering methods as generally defined, such as fungi, algae or bacteria, or can be obtained with the involvement and assistance of fermentation processes.

Linear polymers according to the present invention may, besides the preferred 1,4-α-D-polyglucan, also be other polyglucans or other linear polysaccharides such as, for example, pectins, mannans or polyfructans.

It is additionally possible to obtain linear polymers for producing the microspherical crystallites described in the present invention also from reaction of other nonlinear polysaccharides by treating nonlinear polysaccharides which contain branches with an enzyme in such a way that cleavage of the branches occurs, so that linear polysaccharides are present after removal thereof. These enzymes may be, for example, amylases, isoamylases, gluconohydrolases, or pullulanases.

In a particularly advantageous embodiment of the invention, the microspherical crystallites consist wholly or partly of 1,4-α-D-polyglucan. 1,4-α-D-polyglucan is preferably produced by a biocatalytic (biotransformational) process using polysaccharide synthases, starch synthases, glycosyltransferases, α-1,4-glucan transferases, glycogen synthases, amylosucrases or phosphorylases.

In a further advantageous embodiment, the linear, water-insoluble polysaccharides, especially the 1,4-α-D-polyglucan, are produced by enzymatic treatment of branched or highly branched polysaccharides.

Water is employed exclusively according to the invention for the melting of the linear polysaccharides.

Water is the preferred precipitant; the process can be influenced by using other solvents which are able to replace water wholly or partly, such as, for example, dichloromethane, it being possible to control inter alia the duration of the precipitation process and the texture of the surface of the particles.

Mixtures of water with alcohols, for example methanol, ethanol, isopropanol, are also suitable as precipitants for influencing the process parameters and the properties of the particles.

The temperature during the precipitation process is preferably about 20° C., but higher or lower temperatures can also be used.

It has emerged that it is particularly favorable to purify the polysaccharides used especially the 1,4-α-D-polyglucan, before growing the microspherical crystallites by repeated melting and precipitation in water. This repeated dissolving and precipitating process previous to growing the microspherical crystallites leads to a polysaccharide fraction in which neither low molecular weight saccharides nor proteins or nucleic acids can be detected.

A preferred embodiment of the present invention is therefore a method in which the water-insoluble linear polysaccharide, preferably the 1,4-α-D-polyglucan, is melted and precipitated in water more than once previous to the formation of microspherical crystallites.

The growing of the microspherical crystallites takes place according to the invention by melting the polysaccharides which have been purified as described above, preferably the purified 1,4-α-D-polyglucan, in water under autogenous pressure and a temperature of 130-200° C., and subsequently precipitating at ≦90° C.

It is further possible to influence the process control and the properties of the particles, such as size, size distribution and characteristics—smooth or rough—of the surface, by adding further auxiliaries for growing the crystals.

Suitable auxiliaries which, besides hot or cold water-soluble starch, can be employed are, for example, surface-active substances such as sodium dodecyl sulfate, N-methylgluconamide, polysorbates (e.g. Tween (registered trade mark)), alkyl polyglycol ethers, ethylene oxide/propylene oxide block copolymers (e.g. Pluronic (registered trade mark)), alkyl polyglycol ether sulfates, generally alkyl sulfates and fatty acid glycol esters, sugars such as, for example, fructose, sucrose, glucose and water-soluble cellulose derivatives.

The surface-active substances may be anionic, cationic or nonionic in nature.

It is possible to obtain particularly even, i.e. smooth, surfaces by adding water-soluble cellulose derivatives. It is possible in principle to use a water-soluble cellulose derivative as long as it is suitable as precipitation auxiliary. Chemically modified celluloses of every type are possibilities in this connection. Examples are cellulose esters and cellulose ethers and their mixed forms. Examples of specific representatives are hydroxypropyl-methylcelluloses, hydroxethylcelluloses, carboxymethylcelluloses, cellulose acetates, cellulose butyrates, cellulose propionates, cellulose acetobutyrates, cellulose acetopropionates, cellulose nitrates, ethylcelluloses, benzylcelluloses, methylcelluloses, etc.

It is also possible to employ mixtures of different water-soluble cellulose derivatives.

The particles may have average diameters (number average) such as 1 nm to 100 μm, preferably 50 nm to 10 μm, particularly preferably 100 nm to 5 μm.

The particles show a ratio of the diameter d_{w} to dₙ of (dispersity) 1.0 to 10.0, preferably 1.5 to 5.0, particularly preferably 2.0 to 2.6, where:

dₙ=number average diameter

d_{w}=weight average diameter.

The averages used herein are defined as follows:

dₙ=Σnᵢ×dᵢ/Σnᵢ=number average

d_{w}=Σnᵢ×dᵢ²/Σnᵢ×dᵢ=weight average

nᵢ=number of particles with diameter dᵢ,

dᵢ=a particular diameter,

i=serial parameter.

The term “weight” does not in this case represent mass but represents a weighted mean. The larger diameters are given greater importance; the power of 2 gives a greater weighting to diameters of larger particles.

The dispersity of the distribution of the diameters of the particles is defined as:

D=d_{w}/dₙ

The heterogeneity of the distribution of diameters is defined as:

U=d_{w}/dₙ−1=D−1

A heterogeneity value closer to “0” means the particles are shaped more uniformly in relation to their size distribution.

The microspherical crystallites can be employed advantageously, particularly also because of their uniform shape and size, in various applications, either as such in pure form or by entrapping active substances in the widest sense, thus, for example,

as additives for cosmetics in ointments, dusting powders, creams, pastes, etc.,

as carriers of active substances in pharmaceutical and other applications,

as smoothing agents, for example for closing pores or smoothing slashes,

as food additives, for example as bulking component or for improving rheological properties,

as additive for upgrading, for example, emulsion polymers,

as separation aids, for example in the removal of impurities,

as encapsulating material,

as carrier for magnetic particles,

as filler for biodegradable polymers or industrial polymers for controlling properties,

nucleating aid for promoting crystallization or raising the crystalline content in synthetic bulk plastics,

as additives for controlling properties, for example the porosity, the weight, the color,

as particle standard for calibration or determination of a particle size of unknown materials.

Individual active substances or active substance combinations can be found for example in the following list: pharmaceutical active substances, medicaments, medicinal substances, peptides, proteins, nucleic acids, vaccines, antibodies, steroids, oligonucleotides, flavorings, perfumes, fertilizers, agrotechnical active substances such as pesticides, herbicides, insecticides, fungicides, chemicals with specific properties such as luminous materials, emulsifiers, surfactants, pigments, oxidants, reductants, fullerenes, magnetic complexes, for example paramagnetic compounds.

The invention thus also relates to the use of the microspherical crystallites described above for controlled, for example delayed, delivery of active substances.

The method of the invention comprises a very simple procedure. The parameters for producing the particles can be specified in wide ranges, such as the ratio of solvent to precipitant, temperature during the precipitation process, concentration of the solution, rate of addition of the solution to the precipitant.

The particles are distinguished by a great uniformity in terms of their size and the distribution of their diameters.

The insolubility of the 1,4-α-D-polyglucan, which is preferred according to the invention, in water at <100° C. makes it possible to implement particularly advantageous applications which do not aim a rapid destruction of the microspherical crystallites in water, and can therefore also be used particularly advantageously in products in water is present as a further component.

The microspherical crystallites are distinguished by the ability to be exposed to high mechanical stressability.

In particular, because of their morphology and uniformity, the particles have a smoothing effect, for example on pores.

The 1,4-α-D-polyglucan which is preferably employed can be produced in various ways. A very advantageous method is described in WO 95/31553. The disclosure in this publication is incorporated herein by reference.

The following figures explain the invention in more detail:

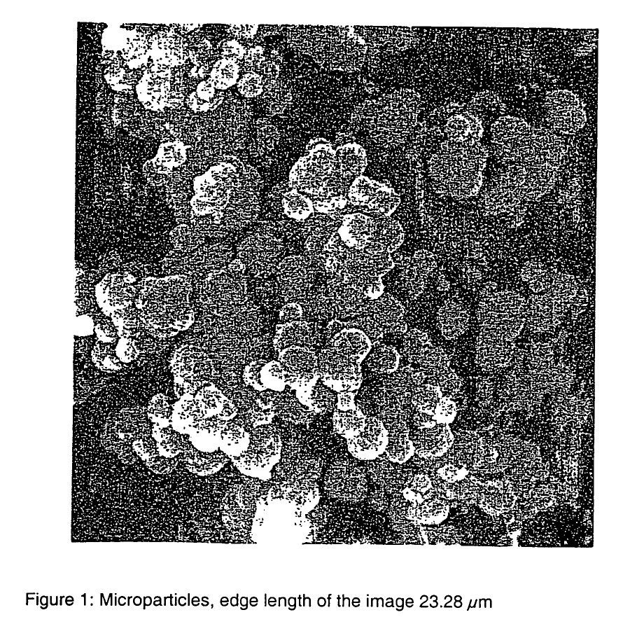

FIG. 1 shows microspherical crystallites produced as in example 1. The edge length of the image is 23.28 μm.

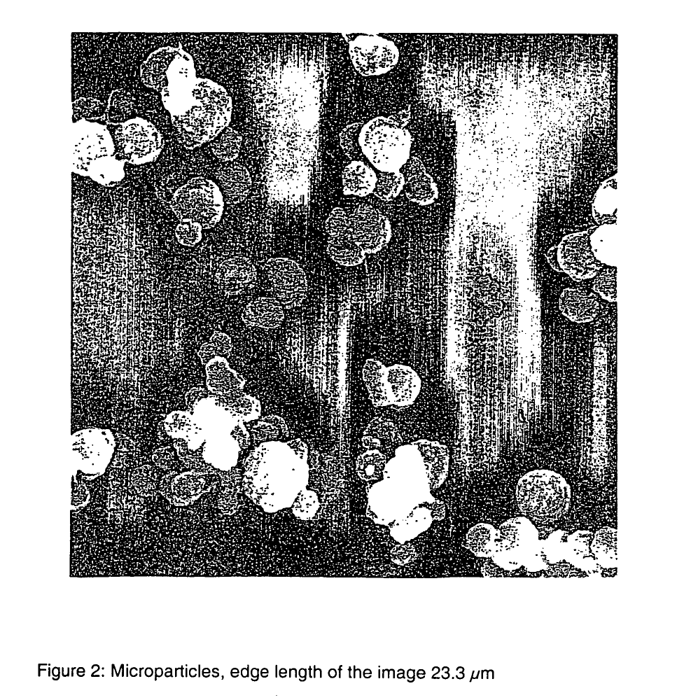

FIG. 2 shows microspherical crystallites produced as in example 1. The edge length of the image is 23.3 μm.

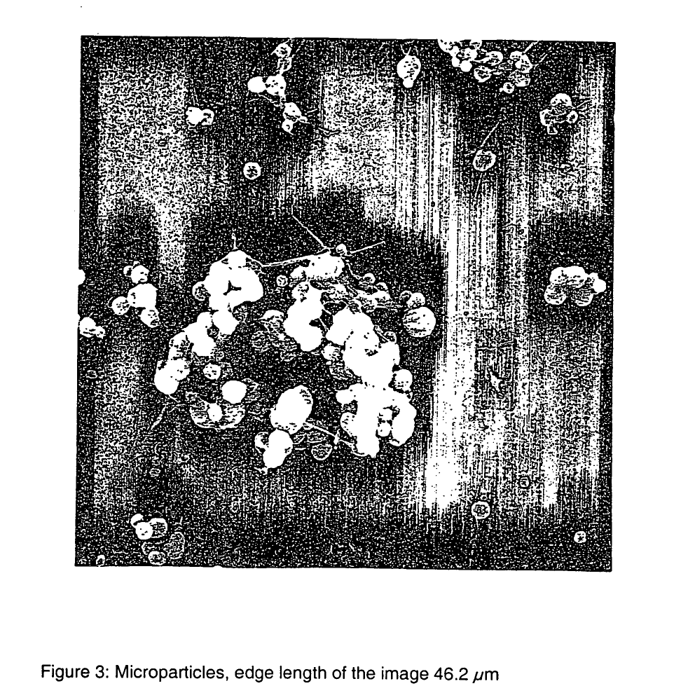

FIG. 3 shows microspherical crystallites produced as in example 6. The edge length of the image is 46.2 μm.

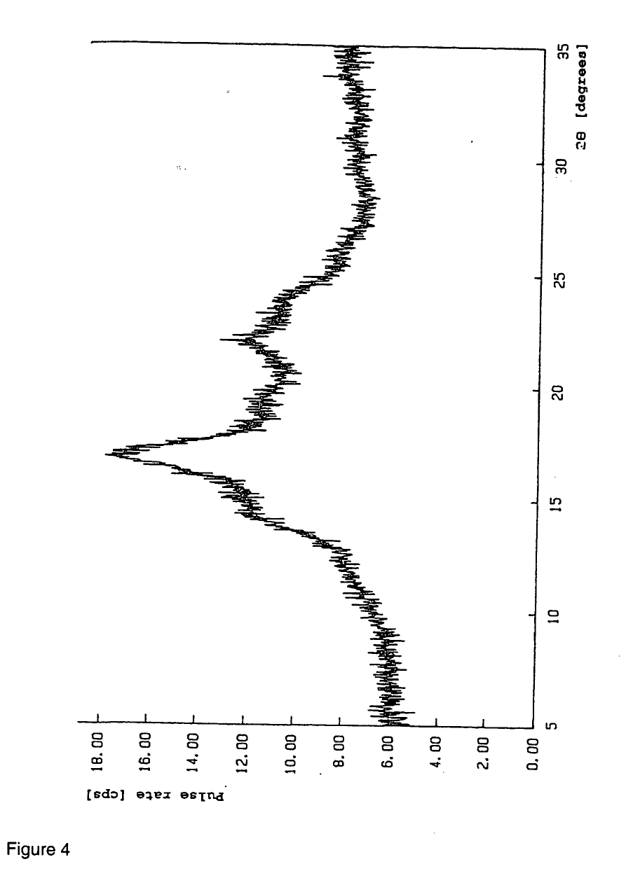

FIG. 4 shows a wide-angle scattering determination of 1,4-α-D-polyglucan, type A in the form of microparticles of the invention. The degree of crystallinity is >95%.

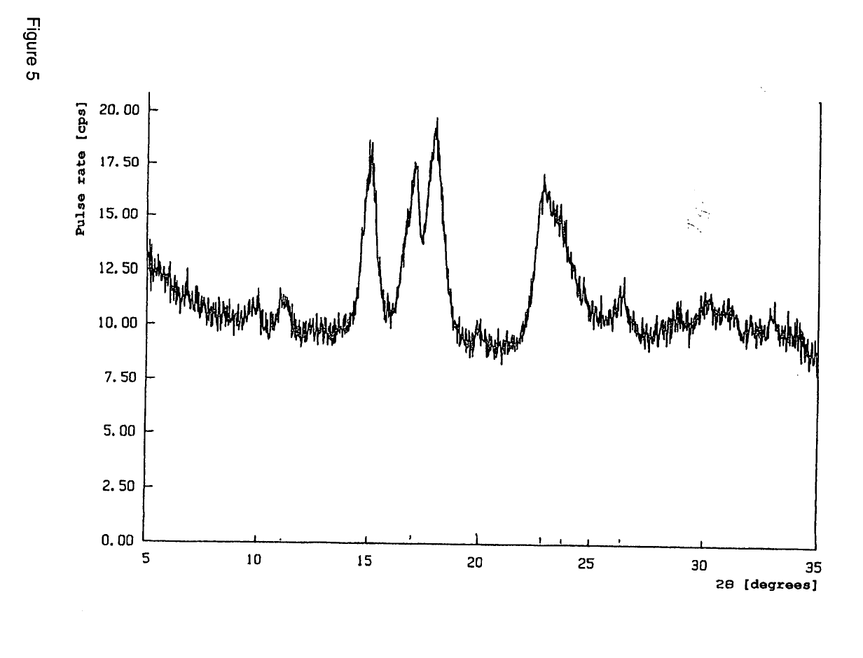

FIG. 5 shows such a wide-angle scattering determination of neoamylose of type B in non-microparticulate form. The degree of crystallinity is <50%.

The invention is explained in more detail by means of the following examples. The examples serve to illustrate and have no limiting significance.

### EXAMPLES

### Example 1

### Production of Microspherical Crystallites from 1,4-α-D-polyglucan

1 g of 1,4-α-D-polyglucan are melted in 5 ml of water and autoclaved at 140° C. The melt is cooled in the autoclave to 80° C. and kept at this temperature for 15 minutes. The suspension is then freeze dried. 850 mg of colorless 1,4-α-D-polyglucan particles are obtained. This corresponds to a yield of 85%. Characterization of the particles took place by means of scanning electron micrographs (SEM, Camscan S-4). The particles are shown in FIG. 1. The edge length of the image is 23.0 μm.

### Examples 2 and 3

In each case 100 mg of 1,4-α-D-polyglucan and an amount of hydroxy-propylmethylcellulose (HPMC, E5Prem., Dow Chemicals) corresponding to the concentration data in table 1 is melted in 5 ml of water in an autoclave at 140° C. The melt is cooled to 90° C. and kept at this temperature for 15 minutes.

The resulting suspension is frozen and lyophilized (freeze drying Christ Delta 1-24 KD).

The results are listed in table 1 below.

TABLE 1

| | Concentration of | Yield |
|---|---|---|
| | HPMC (%) | (%) |
| Example 2 | 1.0 | 98 |
| Example 3 | 10.0 | 89 |

The particles were characterized by means of scanning electron micrographs (SEM, Camscan S-4).

The results are listed in table 2 below.

TABLE 2

| | Example 2 | Example 3 |
|---|---|---|
| Size | 1.0-3.0 μm | 1.0-3.0 μm |
| Shape | Spherical | Almost spherical |
| Surface characteristics | Smooth | Smooth |

### Examples 4 and 5

Influence of the molecular weight of the cellulose derivative on the particle characteristics

The experiments were carried out essentially in analogy to examples 1 and 2 with the exception that HPMC of different molecular weights was used, with E5Prem being low molecular weight in nature and thus of lower viscosity than K15Prem (likewise from Dow Chemical).

As is evident from the results, the resulting particles have the same quality. The molecular weight of the cellulose derivative employed accordingly has a negligible influence on the characteristics of the particles.

The results are compiled in table 3 below.

TABLE 3

| | Example 4 | Example 5 |
|---|---|---|
| Concentration | E5Prem | K15Prem |
| HPMC (%) | 1.0 | 1.0 |
| Yield % | 85 | 90 |
| Size | 1.0-3.0 μm | 1.0-3.0 μm |
| Shape | Spherical | Spherical |
| Surface characteristics | Almost smooth | Almost smooth |

### Example 6

40 g of 1,4-α-D-polyglucan are melted in 100 ml of water in an autoclave at 180° C. The melt is cooled to 80° C. in the closed autoclave and kept at this temperature for 15 minutes. The resultant suspension is frozen and freeze dried. The yield of dry microspherical crystallite is 90%. The microspherical crystallites have an average diameter d_{W} of 100 nm and d_{N} of 90 mm. FIG. 2 was taken in the scanning electron microscope. The edge length of the image is 4.65 μm.

1. A method for producing microspherical crystallites which consist wholly or partly of linear and water-insoluble polysaccharides, which comprises
(i) melting the linear polysaccharide(s) in water at >130° C., and
(ii) producing the microspherical crystallites by precipitation in a precipitant at <90° C.,
where the polysaccharides correspond to solubility classes 4 to 7, preferably to solubility classes 5-7, particularly preferably to solubility classes 6-7 and very particularly preferably to solubility class 7 of the DAB, and where linear means that the degree of branching does not exceed 2.5%.

2. The method as claimed in claim 1, wherein the 1,4-α-D-polyglucan is, previous to the formations of microspherical crystallites, subjected more than once to melting in water, precipitation in a precipitant, separation of the precipitate from the supernatant, discarding of the supernatant, and washing the precipitate where appropriate with water.

3. The method as claimed in either of the preceding claims, wherein the melting is carried out at temperatures of 130° C.-200° C. and the precipitation is carried out at a temperature of 0° C.-90° C., preferably at 20-70° C.

4. The method as claimed in any of the preceding claims, wherein the melting of the polysaccharide and the formation of the microcrystallites are carried out in a closed vessel with the excess pressure of the water vapor.

5. The method as claimed in any of the preceding claims, wherein water or an aqueous medium is used as precipitant.

6. The method as claimed in any of the preceding claims, wherein the melt is produced in the presence of one or more polymers, in particular biodegradable polymers, and/or of one or more active substances.

7. The method as claimed in any of the preceding claims, wherein the polysaccharide employed is produced by a fermentation or enzymatic method.

8. The method as claimed in any of the preceding claims, wherein the melt is produced in the presence of at least one water-soluble cellulose derivative.

9. The method as claimed in claim 6, wherein the enzyme used is selected from the group consisting of: polysaccharide synthase, starch synthase, glycosyltransferase, α-1,4-glucan transferase, glycogen synthase, amylosucrase and phosphorylase.

10. The method as claimed in any of the preceding claims, wherein the polysaccharide comprises poly-1,4-α-D-glucan.

11. The method as claimed in any of the preceding claims, wherein the polysaccharide is exclusively poly-1,4-α-D-glucan.

12. Microspherical crystallites produced as claimed in any of the preceding claims.

13. Microspherical crystallites as claimed in claim 12 with an average diameter of from 1 nm to 100 μm, the particles having a dispersity in a range from 1.0 to 10.0 and being separate.

14. Microspherical crystallites as claimed in either of claims 12-13, which have a degree of crystallinity preferably of >80%, particularly preferably of >90%, very particularly preferably of >95% and most preferably of >98%.

15. Microspherical crystallites as claimed in any of claims 12-14, wherein the linear polysaccharides used to produce them have been produced by enzymatic treatment of branched or highly branched polysaccharides.

16. Microspherical crystallites as claimed in any of claims 12-15 with an average diameter of from 50 nm to 10 μm, preferably 100 nm to 3 μm.

17. Microspherical crystallites as claimed in any of claims 12-16, having a dispersity of the particle diameters d_{w} to dₙ of from 1.5 to 5.0, in particular 2.0 to 2.6.

18. Microspherical crystallites as claimed in any of claims 12-17, which additionally comprise one or more, preferably biodegradable, polymer(s).

19. Microspherical crystallites as claimed in any of claims 12-18, which additionally comprise one or more active substances.

20. The use of microspherical crystallites as claimed in any of claims 12-19 in cosmetic preparations.

21. The use of microspherical crystallites as claimed in any of claims 12-20 in food preparations.

22. The use of microspherical crystallites as claimed in any of claims 12-21 in pharmacological preparations.
